(19) United States
(12) Patent Application Publication
(10) Pub. No.: US 2026/0016927 A1
(43) Pub. Date: Jan. 15, 2026

(54) STEREOSCOPIC DISPLAY SYSTEM FOR SEGMENTATION AND PROOFREADING OF LARGE VOLUMETRIC IMAGE DATA

(71) Applicant: syGlass, Inc., Morgantown, WV (US)

(72) Inventors: Michael Morehead, Mukilteo, WA (US); George Spirou, St. Petersburg, FL (US); Nathan Spencer, Pittsburgh, PA (US); Jason Osborne, Odessa, TX (US)

(21) Appl. No.: 19/266,930

(22) Filed: Jul. 11, 2025

Related U.S. Application Data
(60) Provisional application No. 63/670,051, filed on Jul. 11, 2024.

(51) Int. Cl. G06F 3/04815; G06F 3/01; G06F 3/0346; G06F 3/0482; G06F 3/04845; G06F 3/0487; G06T 15/08; G06T 19/00

(52) U.S. Cl. CPC G06F 3/04815; G06F 3/012; G06F 3/013; G06F 3/0482; G06F 3/04845; G06F 3/0487; G06T 15/08; G06T 19/00; G06F 3/0346; G06T 2200/24; G06T 2210/21; G06T 2210/41; G06T 2219/004; G06T 2219/024

(57) ABSTRACT

Provided is a method for labeling volumetric data, including obtaining, with a computing device, access to volumetric data in a hierarchical spatial data structure, displaying, with the computing device, a multiresolution representation of a three-dimensional image volume in an extended reality environment configured to display volumetric data using the hierarchical spatial data structure, receiving, with the computing device, a selection of a region of interest of the image volume, receiving, with the computing device, user input defining a brush trajectory within the region of interest, determining, with the computing device, which voxels within the image volume that intersect the brush trajectory within the region of interest; and labeling, with the computing device, the identified voxels in memory.

### CROSS-REFERENCE TO RELATED APPLICATIONS

This patent claims the benefit of U.S. Provisional Patent Application 63/670,051, filed 11 Jul. 2024, titled VIRTUAL REALITY PLATFORM. The entire content of each afore-listed patent-filing is hereby incorporated by reference for all purposes.

### BACKGROUND

### 1. Field

The present disclosure relates generally to human-computer interaction and computer graphics and, more specifically, to a virtual reality or augmented reality computing platform.

### 2. Description of the Related Art

Virtual reality (VR) and augmented reality (AR) (or in-general, extended reality, or XR) are powerful tools for teaching, publishing, and disseminating information, offering an immersive experience that significantly enhances learning and understanding. For example, in education, VR captures students' attention by immersing them in interactive environments, making learning more engaging and enjoyable. It allows students to experience otherwise inaccessible situations and environments, such as historical events, distant planets, or the inside of a cell. This experiential learning is particularly beneficial for practical training, providing a safe and controlled environment for activities like medical procedures, engineering tasks, or emergency response drills. Moreover, VR brings high-quality education to remote or underserved areas, ensuring equal learning opportunities regardless of geographic location. It can also adapt to individual learning paces and styles, offering personalized experiences that cater to each student's needs.

In the realm of publishing, VR (and AR) transforms traditional static content into dynamic, interactive experiences, which can enhance user engagement and retention. Authors and publishers can explore new narrative forms and techniques, such as 360-degree videos or virtual worlds, to tell stories in more immersive and impactful ways. Complex information becomes more accessible through visually intuitive and interactive formats, which is particularly useful for scientific or technical publications. Additionally, VR allows for the inclusion of detailed 3D models, interactive diagrams, and other visual aids that enhance the understanding and appreciation of the published material.

For the general dissemination of information, VR (and AR) provides immersive experiences that facilitate deeper understanding and retention. Organizations can use VR to offer virtual tours of facilities, demonstrate products, or showcase events, making information more tangible and relatable. VR bridges geographical distances, allowing people from around the world to access information and experiences that would otherwise be out of reach. Companies and institutions can deliver comprehensive training and education programs through VR, ensuring consistent and high-quality instruction regardless of location. Museums, exhibitions, and conferences can leverage VR to create interactive exhibits and presentations that captivate audiences and provide deeper insights.

Further, VR (and AR) can be useful for interrogating three-and-higher-dimensional data, by providing a third spatial dimension, which in some cases, may map onto the three dimensions of physical space from which data is gathered. Two-dimensional, flat graphs of data often are difficult to visualize in three dimensions, and those interrogating such data can obtain a more intuitive sense of the data by accessing it through a user interface that is designed for three spatial dimensions.

### SUMMARY

The following is a non-exhaustive listing of some aspects of the present techniques. These and other aspects are described in the following disclosure.

Some embodiments provide a computer-implemented method for presenting or viewing extended reality data.

Some embodiments provide a computer-implemented method for labeling volumetric data, including obtaining, with a computing device, access to volumetric data in a hierarchical spatial data structure, displaying, with the computing device, a multiresolution representation of a three-dimensional image volume in an extended reality environment configured to display volumetric data using the hierarchical spatial data structure, receiving, with the computing device, a selection of a region of interest of the image volume, receiving, with the computing device, user input defining a brush trajectory within the region of interest, determining, with the computing device, which voxels within the image volume that intersect the brush trajectory within the region of interest; and labeling, with the computing device, the identified voxels in memory

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 illustrates an extended reality computing environment according to some embodiments of the present techniques;

FIG. 2 is a block diagram depicting an example of the volumetric image processing method in accordance with some embodiments of the present techniques;

FIG. 3 is a block diagram depicting an example of the volumetric image processing method in accordance with some embodiments of the present techniques;

FIG. 4 is a block diagram of an example computing device by which the present techniques may be implemented in accordance with some embodiments of the present techniques.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of human computer interaction, computer graphics, and data science. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Stereology can be helpful for quickly analyzing large data sets. However, 3D segmentation is a difficult and time-consuming task performed in many research labs and other organizations. Often, segmenting 3D objects (like medical scans, simulation results, volumetric scans of fluids or structures, etc.) in 2D (e.g., monitors) is difficult and generates too many errors, in part due to the limitations of non-stereoscopic views and because both rendering and interacting with large datasets is difficult. For instance, some approaches entail slide-by-slice annotation of data with three spatial dimensions in a two-dimensional, non-stereoscopic display, which can be slow, expensive, and error prone. And some approaches to annotating or otherwise interrogating data in a stereoscopic (e.g., XR) user interface rely on inputs from 2D UIs, like with a mouse configured to register movements in two dimensions, slowing input, and potentially inducing errors. In part, this is done because faster input methods could reveal lag and stutter when views change quickly, due to the limits of computing resources available. None of which is to suggest that any of these approaches are disclaimed or disavowed, or that discussion of any other tradeoffs herein constitutes disclaimer or disavowal.

Some embodiments segment volumetric image data through interaction within an extended reality environment such as virtual reality or augmented reality. A computing system may construct a visualization of a three-dimensional image volume using a hierarchical spatial data structure capable of storing and accessing image blocks at multiple levels of resolution. A user may interact with the volumetric data using spatial input to define a trajectory through the extended reality space. Voxels intersected by the trajectory may be identified, mapped to subsets of the volumetric data, and labeled. Some embodiments support spatial interaction directly within the three-dimensional coordinate space of the volumetric data, avoiding reliance on two-dimensional projections or slice-based workflows that can disrupt anatomical continuity or reduce segmentation precision. By organizing the data into a hierarchical spatial structure with multiple resolution levels, and by allowing interaction through immersive input modalities such as tracked controllers or gaze-based selection, some embodiments address technical challenges associated with computing-performance-constrained environments. These include, in some embodiments, potentially reducing local memory load, reducing rendering latency, and improving segmentation accuracy in large, high-resolution datasets that are not managed using other visualization and labeling approaches.

In some embodiments, voxels may be labeled according to a segmentation scheme defined in three-dimensional space (like three spatial dimensions in a virtual space), where each label corresponds to a different structure, region of interest, or other volumetric classification category relevant to the dataset. The labels may be assigned through interactive input, algorithmic processes, or a combination thereof, and may support both single-label and multi-label configurations. The resulting label data may be stored in a sparse, structured format, such as a sparse octree or other hierarchical data structure that allocates memory only for those spatial regions containing labeled voxels.

In some embodiments, resolution of the presented data may vary dynamically based on factors such as user viewpoint, gaze direction, or interaction history, allowing selected portions of the volume to be presented at higher data resolution relative to other regions (though, in some cases, pixel resolution may be constant as the resolution within data space is varied). The hierarchical data structure may take various forms that include octrees or other space-partitioning data structures and may support efficient propagation of segmentation updates across resolution levels. Some embodiments may be applied in domains such as medical imaging, anatomical annotation, or classroom-based instruction, where users engage with large-scale or time-resolved volumetric image datasets through immersive, voxel-level interaction.

Some aspects include a method for labeling volumetric data, including obtaining, with a computing device, access to volumetric data in a hierarchical spatial data structure, displaying, with the computing device, a multiresolution representation of a three-dimensional image volume in an extended reality environment configured to display volumetric data using the hierarchical spatial data structure, receiving, with the computing device, a selection of a region of interest of the image volume, receiving, with the computing device, user input defining a brush trajectory within the region of interest, determining, with the computing device, which voxels within the image volume that intersect the brush trajectory within the region of interest; and labeling, with the computing device, the identified voxels in memory.

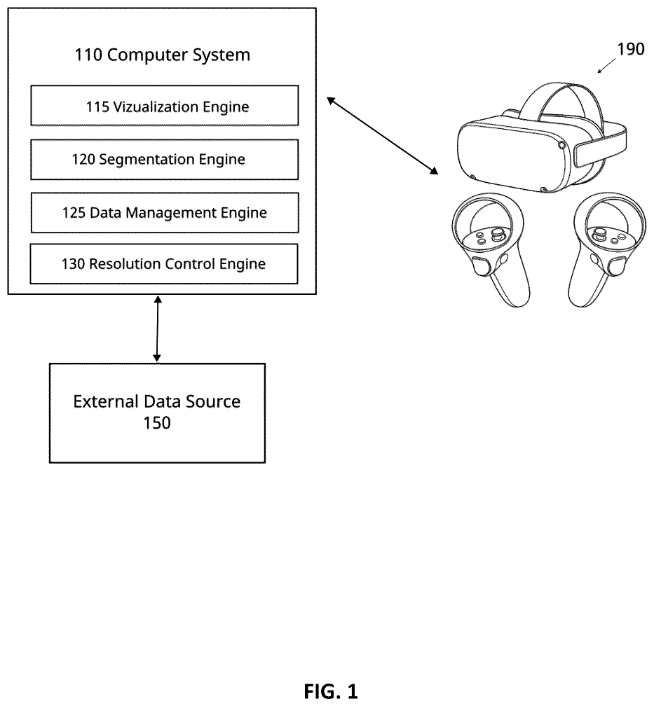

FIG. 1 illustrates an example system architecture, which may be used for immersive segmentation of volumetric data. The system may include a computing system 110 configured with (e.g., programmed to execute) multiple modules, including a visualization engine 115, segmentation engine 120, data management engine 125, and resolution control engine 130. The term “engine” is used to refer to bodies of code or logic that collectively perform some function. That code or logic may be intermingled with that of the other “engines” or may be compartmentalized. The processing engines together may facilitate dynamic rendering, label application, and hierarchical memory management across multiresolution data volumes.

The system may also include a head-mounted spatial interaction system 190 (such as a VR or AR headset), which provides the user with an immersive interface to view and interact with large-scale three-dimensional datasets using tracked gestures and input. Some embodiments are expected to help users to intuitively segment image volumes with high spatial awareness, while assisting the system to adjust performance and resolution in real time based on user focus, view, and interaction patterns. Other examples include non-head-mounted interfaces, such as stereoscopic displays on a desktop, light-field displays, or holographic displays.

In some embodiments, the system may receive volumetric image data (which refers to the data that is to-be imaged and should not be confused with the values assigned to pixel intensities based on that data in the display) from an external data source 150 (or which may be local). For example, the volumetric image data may include a stack of 512×512×256 or larger voxel grayscale images sensed by a magnetic resonance imaging (MRI) scan of a subject's brain. The data management engine 125 may (e.g., before a data viewing session, as part of a pre-processing pipeline) organize the image volume into a sparse hierarchical spatial data structure with multiple resolution levels, such as an octree, k-d tree, skiplist, spatial hash, directed acyclic graph, or quadtree (or combinations thereof, like an octree with a skiplist, and which is not to imply here or elsewhere that items in the list refer to non-overlapping categories). In some embodiments, blocks at a base resolution level may correspond to subvolumes of 64×64×64 voxels, with finer levels representing progressively smaller spatial subdivisions. As the user views the dataset through the head-mounted spatial interaction system 190, the resolution control engine 130 may adjust data resolution levels dynamically based on user viewpoint, increasing resolution in regions near the gaze direction or brush path while maintaining lower resolution for out-of-view blocks. The user may, with input by gesture tracking of their hands through cameras or an inertial-measurement unit bearing hand-held sensor, or combination thereof) define a three-spatial dimensional brush trajectory using a tracked input device to identify a structure of interest and the segmentation engine 120 may identify voxels in intersected blocks and apply a segmentation label corresponding to an anatomical class such as “left lateral ventricle.” The segmentation labels may be stored in a sparse octree structure using bitfields to represent the presence or absence of particular segmentation masks in each block.

The computing system 110 shown in FIG. 1 may be implemented in various hardware and software configurations. In some embodiments, the computing system 110 may be a single local computing device, such as a desktop workstation, laptop, or other integrated graphics processing unit (GPU)-enabled system. In other embodiments, the computing system 110 may be distributed across multiple physical (e.g., geographically distributed) or virtual machines and may be implemented using a cloud computing environment. For example, some or all of the functionality performed by the computing system 110 may be provided by a virtualized server instance, containerized service, or network-accessible infrastructure hosted remotely and communicatively coupled to the head-mounted spatial interaction system 190 over a wired or wireless communication interface.

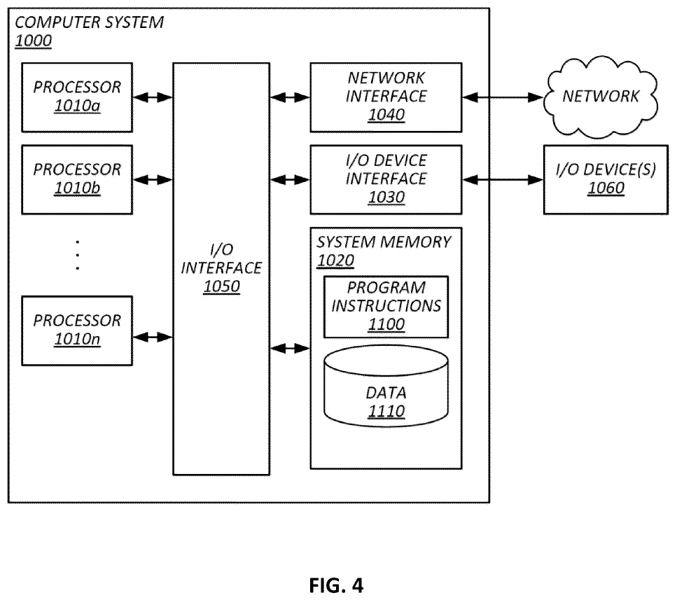

In certain embodiments, the computing system 110 may be implemented with the computing device illustrated in FIG. 4. One or more engines illustrated in FIG. 1—including the visualization engine 115, segmentation engine 120, data management engine 125, and resolution control engine 130—may be implemented in software, hardware, or a combination thereof. These engines may be executed entirely on the local computing system 110 or may be distributed between client-side and server-side components. For instance, volumetric data rendering may be performed locally while segmentation processing or hierarchical data storage is managed by a remote system. The interaction between these engines may occur via direct memory access, inter-process communication, network-based APIs, message queues, or other techniques for orchestrating modular processing systems in local or distributed architectures.

The visualization engine 115 may be responsible for generating visual output corresponding to the three-dimensional image volume and presenting that output in an extended reality (XR) environment such as virtual reality (VR) or augmented reality (AR) environment through the head-mounted spatial interaction system 190 (or other type of display). In some embodiments, the visualization engine 115 may generate a sequence of stereoscopic frames (based on a current pose of the headset and may be configured to update rendered frames at a refresh rate sufficient to maintain immersive interaction—such as 60 Hz, 72 Hz, or higher (e.g., at greater than 24 Hz, like greater than 60 or 120 Hz, which are expected to reduce motion sickness from longer sessions). The visualization engine 115 may receive scene data from the data management engine 125, including spatial block metadata, resolution level information, and voxel content for one or more regions of the image volume. Based on this data and a camera model defined by the user's current viewpoint in virtual space, the visualization engine 115 may generate images using volume rendering techniques, such as ray marching, maximum intensity projection (MIP), or direct volume rendering (DVR), with transfer functions applied to map voxel intensities to color and opacity.

Different coordinate systems for different spaces may be relevant to some embodiments. The user may reside in physical space, and the user may move their head, body, hands, etc., through three spatial dimensions of physical space, e.g., while the headset tracks and a hand-held tracking device tracks movement through physical space (e.g., with three or six axes for each). A stream of such changes may be input to the illustrated system from those devices, and drivers or the like may respond to inputs in those multiple channels of data to perform the described updates to the display.

That display may be presented in a three spatial-dimensions of a virtual space. The user's head may be assigned a six-dimensional pose (e.g., with three position dimensions, x, y, z, and three orientation dimensions, roll, pitch, and yaw angles) corresponding to channels indicating changes to (or absolute values of) the same sensed by the headset. Hand-tracking devices may have the same in physical and virtual spaces. In some cases, movements may correlate on a one-to-one bases between virtual and physical space, or they may be scaled (e.g., with a user-adjustable multiplier).

That virtual space may be presented in pixel space, e.g., with x and y coordinates of pixels, for instance each having three sub pixels corresponding to different colors, for each two stereoscopic displays). And in virtual space, what is referred to as image data may be positioned and oriented, such that the user can view and label that data by moving in physical space to change pose in virtual space to view that image data. In some cases, the system may provide inputs by which the user may reposition or reorient the image data in the virtual space (e.g., making it spin or move closer or further without otherwise changing their position physical space). The image data may specify another three spatial dimensional space, e.g., with additional dimensions assigned to different locations therein.

In some cases, those three spatial dimensions may represent spatial dimensions in a volume (like an object) characterized by the data, with sensed values at each point having a location in that space. Image data space may be scaled relative to virtual or physical spaces or they may be one-to-one, e.g., a seismic data may depict three dimensional values over several hundred yards, but the user would not necessarily be required to walk several hundred yards to move from one end to the other, or semiconductor imaging, like with from focused ion beam slices imaged with an electron microscope, may be scaled up such that movement in physical space is appropriately scaled to movement around the imaged structure.

In some cases, the image data may be characterized at multiple resolutions of image data space, for instance with voxels of varying size. In some cases, a given lower-resolution voxel may characterize (e.g., with a scalar or vector of values characterizing the volume, like averages, means, modes or other measures of central tendency of data values therein) a larger cubic volume in data space with a cube and a next-higher-resolution set of voxels (like 8 adjacent cubes of equal dimensions filling the larger afore-mentioned cube, with four arrayed above and four arrayed below in a two-dimensional matrix at each of these two spatial layers) may characterize that same volume with 8 such scalars or vectors corresponding to (e.g., the same measure of central tendence) data contained in each of those respective smaller cubes. This arrangement may be repeated recursively subdividing the same spaces into higher and higher resolution.

In some embodiments, the visualization engine 115 may determine which portions of the image data to depict at high or low resolution (in data space) based on input received from the resolution control engine 130. For instance, blocks intersecting a view frustum centered on the user's head pose in virtual space may be flagged for display at full resolution, while peripheral regions may be visualized at a lower resolution or excluded from rendering entirely. The visualization engine 115 may also respond to updates from the segmentation engine 120, such as overlaying segmentation masks, highlighting user-selected regions of interest, or compositing segmented labels atop base grayscale or color-mapped volumetric data. In implementations involving transparency or composite layers, the visualization engine 115 may perform shader-based rendering operations using GPU acceleration to combine original volumetric data with segmentation layers or annotations in real time.

The visualization engine 115 may output rendered frames to the display hardware of the head-mounted spatial interaction system 190 using low-latency video pipelines and may also receive periodic updates from the system's spatial tracking subsystem to adjust rendering parameters in response to user movement. In some embodiments, the visualization engine 115 may also be configured to render user interface (UI) elements, such as crosshairs, virtual menus, brush outlines, or annotations, within the same stereoscopic context to support naturalistic interaction with the data. The visualization engine 115 may interact with other components of the computing system 110 through shared memory, rendering queues, or asynchronous messaging to support synchronization between data access, segmentation state, and display output.

In some embodiments, the visualization engine may allow the user to accept the overlay in its entirety, selectively erase regions, or continue painting additional gestures. Each user action that alters the overlay may be recorded together with the raw network output logits, supporting subsequent learning processes to associate correction patterns with corresponding model predictions. The voxel volume may be stored in a hierarchical sparse data structure in which each node maintains a dirty flag that is set when a gesture intersects that node. The segmentation engine may restrict the collection of blocks forwarded to the inference service to those nodes whose dirty flags are asserted, thereby limiting computation and memory traffic.

The segmentation engine 120 may be configured to receive spatial input from the head-mounted spatial interaction system 190 and apply segmentation labels to selected regions of the volumetric image data. In some embodiments, the segmentation engine 120 may receive user input in the form of a brush trajectory defined by a tracked input device, such as a virtual controller or stylus, and compute a volumetric interaction region based on the brush's position, orientation, and shape. Brush geometry may include spheres, cubes, axis-aligned disks, or other volumetric primitives that define a spatial region for label application. The segmentation engine 120 may determine which voxels intersect the defined interaction region and apply one or more segmentation labels to those voxels based on user input, predefined label classes, or prior segmentation history.

The segmentation engine 120 may interface with the data management engine 125 to determine the hierarchical block structure associated with the segmented region and may operate on voxel data stored at various resolution levels. In some embodiments, the segmentation engine 120 may mark blocks that contain modified voxels as dirty, triggering resampling operations such as upsampling to finer levels or downsampling to lower-resolution caches in coordination with the resolution control engine 130. The segmentation engine 120 may further interface with a segmentation data structure implemented as a sparse octree or similar hierarchical structure, where each block includes a bit field or other encoding indicating the presence of one or more mask identifiers. Bit fields may be used to track segmentation labels across the hierarchy, allowing for efficient lookup, deletion, or reallocation of mask identifiers across large image volumes.

The bit fields may be a compact data representation used to indicate the presence or absence of values, such as segmentation labels, mask identifiers, or voxel states, within a given spatial block or node. A bit field may be implemented using a fixed-width integer, an array of binary flags, a dynamically allocated bitmap, or any other structure that allows binary state information to be stored, retrieved, or updated with minimal memory overhead. In the context of segmentation, a bit field may indicate which mask identifiers are active within a given block, such that each bit position corresponds to a logical mask index. The use of bit fields allows for efficient querying, propagation, and management of segmentation metadata across resolution levels and supports operations such as mask reuse, global deletion, and visualization overlay without requiring per-voxel inspection.

In some implementations, the segmentation engine 120 may support multi-class labeling, where a voxel (at various levels of the hierarchy described above, with values or operations assigned to lower-resolution voxels being mapped to higher-resolution voxels therein) may be associated with more than one segmentation label, such as when performing comparative annotation or proofing. Label application may be visualized in real time through the visualization engine 115 as an overlay or composited mask. In some embodiments, the segmentation engine 120 may also support user-driven segmentation refinement workflows, where corrections to an existing machine-generated segmentation may be logged, associated with a given anatomical or categorical label, and optionally linked to user annotations for later use in training a machine learning model. Additional functions of the segmentation engine 120 may include tracking label usage, managing mask propagation across time steps in 4D datasets, or responding to context-sensitive editing constraints, such as immutability of prior masks or mask exclusivity within a given block.

In some embodiments, an inference module may be communicatively coupled to a segmentation engine through an inter-process messaging interface. When the segmentation engine receives data describing a volumetric-interaction gesture, such as a brush trajectory, the engine may identify a set of volume blocks whose spatial extents intersect a swept volume produced by that gesture and may transmit identifiers for those blocks to an inference service. The inference service may execute locally on GPU, on a CPU, or on a local or remote AI accelerator reachable via a network connection. The service may load voxel tensors for each referenced block and may apply a three-dimensional convolutional neural network (such as a U-Net architecture) or an attention-based neural network (such as a transformer model) to generate, for each voxel, a vector of class-membership likelihoods.

In further embodiments, the inference service may stream model parameters on demand to accommodate limited device memory, may quantize activations to fixed-point formats when executing on a digital signal processor, or may batch multiple pending gesture requests to amortize accelerator latency. The segmentation engine may cache probability maps for blocks that have not been invalidated by subsequent gestures and may reuse the cached data to avoid redundant inference.

In some embodiments, a volume-management module may maintain, for each node of a hierarchical sparse voxel store, a fixed-width bit field in which each bit position may indicate the presence of a particular segmentation label within the corresponding block. An additional position in the same field may be reserved for an “AI-proposed” state that may denote the existence of at least one voxel whose classification has not yet been confirmed by a user. When an inference module streams a classification tensor into the subsystem, a traversal routine may iterate through the tensor in cache-line order, may set the accepted-label bits for voxels whose user mask already contains a definitive identifier, and may set the AI-proposed bit whenever the routine encounters a voxel whose predicted label differs from the current mask and whose confirmation flag remains unset. The routine may complete by writing the updated bit field to a ledger entry associated with the block, thereby preserving atomicity across concurrent editing threads.

The data management engine 125 may be responsible for constructing, maintaining, and traversing a hierarchical spatial data structure used to store volumetric image data and associated segmentation labels. In some embodiments, the hierarchical spatial data structure may include an octree. Some embodiments may use a recursively defined spatial partitioning structure wherein each block at a given resolution level corresponds to a spatial subvolume of the image volume. Each such block (e.g., cube) may optionally be associated with, e.g., eight child blocks at a higher resolution level, where the child blocks represent finer subdivisions of the same spatial region. The data management engine 125 may manage the resolution-level hierarchy and establish mappings between blocks at different levels to support consistent access and efficient update propagation.

The data management engine 125 may organize the image volume into a multiresolution representation such that blocks may be accessed or modified independently of one another, without requiring traversal or loading of unrelated blocks. In certain embodiments, blocks may be sparsely populated based on content—e.g., masking or sampling density—and may be instantiated lazily in response to user interaction or system demand. The data management engine 125 may coordinate with the segmentation engine 120 to identify and allocate blocks corresponding to regions intersected by user input and may flag blocks as dirty or pending update in response to voxel-level modifications.

In some embodiments, the data management engine 125 may construct and manage a hierarchical spatial data structure in the form of an octree to organize volumetric image data. Some embodiments may use a tree-based spatial indexing structure in which each internal node subdivides three-dimensional space into eight non-overlapping child nodes, or octants, each corresponding to a smaller spatial subvolume. The root node of the octree may represent the entire bounding volume of the dataset, and each subsequent level of the tree may represent increasingly fine subdivisions of that space. This recursive partitioning is expected to support efficient spatial localization, multiresolution access, and resolution-aware rendering and segmentation.

Depending on system requirements and data characteristics, different variants of octree structures may be used. In some embodiments, the data management engine 125 may implement a dense octree, in which each node is preallocated with all eight children regardless of data sparsity. This may be appropriate for uniform datasets or environments where memory is not a limiting factor. In some embodiments, the system may use a sparse octree, in which child nodes are instantiated only when required, such as when the corresponding subvolume contains nonzero voxel data, active segmentation labels, or has been modified through user interaction. The octree structure may also support lazy evaluation, where subdivision occurs only when a node is accessed, edited, or rendered, and may optionally support reverse coarsening, where leaf nodes are collapsed when their contents become redundant or irrelevant. This flexibility supports a wide range of operational modes, including streaming, out-of-core processing, and progressive refinement during interactive segmentation workflows.

Some embodiments may encode image data in higher spatial-dimensional data structure, like a k-d tree (or k-dimensional tree) as a space-partitioning data structure for organizing points in a k-dimensional space. Examples may include data with four spatial dimensions, e.g., where one spatial dimension is mapped to time in the UI, and each block has 16 blocks therein, other than those at a highest level of resolution.

In some embodiments, the recursive subdivision process described above may be performed using a quantized spatial mapping, in which each level of the hierarchy corresponds to a discretized grid of axis-aligned cubic regions in data space. During construction, the data management engine 125 may apply a quantization operation to voxel coordinates, partitioning the three-dimensional space into fixed-size cubic bins where each bin maps to a potential node at a given resolution level. For each voxel or data element, its position may be converted into quantized coordinates—such as by applying integer division, bit-shifting, or normalized rounding. At the coarsest level, the root node may represent the entire dataset volume, with each of its eight child nodes occupying an equally sized portion of that volume formed by bisecting along each principal axis. This subdivision may proceed recursively (which is not to imply that the code implementing this must be written with recursion), with each child node defining a smaller, grid-aligned subvolume derived from its parent. The use of quantized coordinate bins may provide consistent alignment between resolution levels, simplify traversal logic, and support data placement strategies that reduce reliance on floating-point arithmetic or per-voxel spatial searches.

In some embodiments, blocks at coarser (or lower) resolution levels, such as those representing higher-level nodes in the hierarchical spatial data structure, may store aggregated representations of the volumetric data within their corresponding spatial subvolumes. These coarse-grained blocks may be associated with summary values computed from the contents of their descendant blocks or voxels. For example, a block at a lower resolution level (i.e., coarser granularity) may be assigned a representative value computed using a measure of central tendency over the finer-resolution data it encompasses. The specific measure may vary by implementation and may include, a mean (e.g., an average intensity or label), median, mode, or another statistical or algorithmic function suitable for the underlying data type (other examples include a max, a min, a measure of variance, or the like). In certain implementations, these representative values may also be generated using a machine learning model trained to predict or synthesize coarse representations based on known characteristics of the dataset or prior examples.

In some embodiments, each node within the hierarchical spatial data structure may store associated metadata that augments or enhances the functionality of the rendering, segmentation, or interaction subsystems. This metadata may include, for example, material properties (e.g., opacity values, rendering color, surface reflectance parameters), segmentation metadata (e.g., label confidence scores, source model identifiers), or user interaction data (e.g., last edited timestamp, user ID, or edit confidence level). This per-node metadata may be stored in line with the hierarchical structure or maintained in an auxiliary mapping indexed by node address or spatial key. The incorporation of metadata may be used to drive rendering behavior or to control access to nodes during collaborative or multi-user workflows, where permissions or review state may vary by region. Metadata may also facilitate downstream analysis or reporting, such as tracking which blocks were proofed, revised, or flagged for review during a segmentation session.

In some implementations, nodes in the hierarchical data structure may also include references to or be associated with auxiliary spatial data structures to support advanced operations. For instance, one or more nodes may reference a bounding volume hierarchy (BVH) to accelerate geometric intersection tests, such as in ray-based queries or collision detection tasks. In other cases, the node may be linked to a k-d tree or similar structure used for point-based proximity queries, subregion indexing, or spatial sorting. These linked structures may be built dynamically or precomputed and may allow the system to execute multi-layered spatial queries that span beyond the native hierarchical partitioning of the octree itself.

In some embodiments, the hierarchical spatial data structure may be indexed according to a space-filling curve. Some embodiments may map multi-dimensional data (e.g., 3D spatial coordinates) to a one-dimensional ordering while preserving spatial locality. Examples include Morton order (Z-order curve), Hilbert curves, and Peano curves. When applied to volumetric datasets, such curves may be used to determine the linear storage layout of hierarchical blocks or voxel ranges within memory, storage, or transmission buffers. The organization of nodes or blocks along a space-filling curve may allow for improved data locality, cache coherence, and streaming performance, especially in applications where block traversal occurs in predictable spatial patterns. For example, adjacent blocks in 3D space may be stored near one another in memory or on disk, reducing page faults and improving bulk transfer efficiency. The ordering may also assist in multi-resolution compression, out-of-core paging, or parallel workload distribution by partitioning the 3D volume into linearly ordered regions with bounded locality loss.

In some implementations, the system may apply compression techniques at the block or node level to reduce memory consumption. Compression may be applied to voxel intensity values, segmentation labels, or bit field metadata associated with each block. Suitable compression methods may include run-length encoding (RLE), dictionary-based compression, predictive schemes, or sparse matrix encodings. Compression may be applied selectively to avoid degrading interactive responsiveness. Decompression may be performed on-demand when a block is accessed, edited, or rendered. These memory reduction strategies may be used to extend the addressable size of the image volume or improve cache utilization.

The system may support dynamic updates to the tree in response to changes in the three-dimensional object or image volume. Such changes may include transformations applied to the object (e.g., scaling, rotation, or translation) as well as changes in the underlying data, such as when new volumetric slices are added, voxel values are edited, or segmentation masks are modified. In response to such changes, the data management engine 125 may update the affected portion of the tree, reindexing nodes, recalculating bounding volumes, or marking blocks for recomputation or re-rendering.

The data management engine 125 may implement querying operations that retrieve, inspect, or operate on specific regions or features of the volumetric image data. The recursive, spatially localized nature of the octree structure, in some embodiments, is expected to allow the system to direct queries toward only those portions of the dataset relevant to the task at hand. A query may begin at the root node, which defines the spatial extent of the image volume, and proceed downward through the hierarchy by evaluating whether each child node intersects a defined region of interest. This approach may be used in conjunction with collision detection, user interaction tracking, or view-frustum-based resolution selection. For example, when the system receives a brush trajectory or determines a change in user viewpoint, it may initiate a traversal that identifies nodes intersecting the path or viewing volume. Nodes that fall outside the region being analyzed may be skipped entirely, reducing the number of computations and memory accesses compared to flat or uniform data structures. This is expected to mitigate some of the above-mentioned concerns with lagging and skipping frames, which can be particularly problematic in XR displays and can induce feelings of discomfort if not handled properly.

In addition to geometric queries, the data management engine 125 may also support logical queries based on metadata or segmentation state. For example, blocks may be queried based on whether they contain voxels associated with a particular segmentation label, whether a bit field is active for that block, or whether the block has been flagged with a state such as dirty, proofed, or locked. These queries may operate across one or more resolution levels, supporting workflows such as global mask removal, label reassignment, or multi-resolution consistency checks. This traversal process may also apply to operations involving level-of-detail rendering, occlusion culling, and ray-based inspection, in which the system considers both spatial alignment and semantic criteria before processing a node. For instance, during view-based rendering, blocks outside the frustum or marked as empty may be bypassed entirely, while during a segmentation audit, blocks containing inconsistent label transitions may be selected for further review.

In addition to raw voxel intensity data, the data management engine 125 may manage segmentation metadata, mask identifiers, and block-level status indicators, such as whether a block has been edited, viewed, or proofed. In some embodiments, block metadata may include one or more bit fields representing segmentation mask presence across resolution levels, and these bit fields may be traversed by the segmentation engine 120 or resolution control engine 130 to perform global operations such as finding an unused segmentation label or identifying all blocks containing a particular mask. The data management engine 125 may also support the compression, streaming, or external storage of volumetric data, and may manage data exchange between the computing system 110 and the external data source 150 using network, file-based, or memory-mapped interfaces. It may further support per-time-step hierarchy instantiation for 4D datasets, with a separate tree structure allocated for each temporal volume, facilitating temporal segmentation workflows.

The resolution control engine 130 may be configured to manage the selection and adjustment of resolution levels used to display and interact with portions of the three-dimensional image volume during a segmentation session. In some embodiments, the resolution control engine 130 may interface with the head-mounted spatial interaction system 190 to receive positional and orientation data representing the user's current viewpoint. Based on these data, the resolution control engine 130 may define a view frustum or foveal region and determine which portions of the hierarchical spatial data structure fall within or outside of that region. Blocks located within or intersecting the user's current view may be selected for display at a higher resolution, while blocks located outside the field of view may be rendered at a lower resolution or not accessed at all, thereby conserving memory and compute resources.

In some implementations, the resolution control engine 130 may issue resolution scaling instructions to the visualization engine 115, such that the rendered output adapts in real time based on user movement or focus. In other cases, the resolution control engine 130 may instruct the data management engine 125 to load or prefetch blocks at a resolution appropriate to a predicted view path, such as based on prior gaze patterns or input gestures. The resolution control engine 130 may further respond to segmentation edits performed by the segmentation engine 120 by triggering resolution adjustments in affected blocks. For example, when a block is edited at an intermediate resolution, the resolution control engine 130 may coordinate an upsampling operation to regenerate finer-resolution versions of that block for export or refinement and may also perform downsampling to update coarser previews or cached visualizations.

The resolution control engine 130 may also implement memory or bandwidth management policies to enforce upper limits on the number of high-resolution blocks simultaneously active in the system. In some embodiments, the engine may operate a priority queue or cache eviction policy, retaining blocks nearest to the user's viewpoint or most recently edited, while evicting those least likely to be revisited. The engine may further support resolution tiering across time steps in 4D datasets, supporting adaptive detail allocation based on temporal proximity or time-synchronized editing events. By adjusting data resolution in response to user interaction and system state, the resolution control engine 130 may support low-latency visualization and editing of volumetric image datasets significantly larger than the computing system's available memory.

For purposes of this description, the terms “lowest resolution level” and “highest resolution level” refer to positions within the hierarchy in terms of spatial granularity. The lowest resolution level corresponds to the coarsest subdivision of the image volume (e.g., the root node or top-level block), which typically encompasses the largest spatial extent and contains the fewest subregions. Conversely, the highest resolution level refers to the finest subdivision, often at the level where voxel-level data is stored or manipulated directly. Each successive level between the lowest and highest resolutions may represent an intermediate scale, with blocks subdividing the spatial extent of their parent block into smaller, more detailed regions. This terminology is not intended to imply temporal order or numeric indexing unless explicitly specified elsewhere.

In some embodiments, a down-sampling encoder path may apply three-dimensional convolutions, normalization layers, and rectified-linear activation functions to capture context at multiple resolutions, while an up-sampling decoder path may employ transposed convolutions and skip connections to fuse high-resolution detail with deep semantic features. A final one-by-one-by-one convolution followed by a softmax function may convert decoder outputs into normalized likelihoods. The service may return each probability map to a visualization engine, which may blend the map with existing imagery as a translucent overlay, thereby allowing a user to preview a predicted fill.

In some cases, image data may be sensed over time and may unfold over time. Some embodiments may have frames of image data, with each frame being a k-d tree, like an octree, corresponding to a time slice. Some embodiments may implement compression techniques like those used in video, e.g., with i-frames and b-frames characterizing all data at a time slice and other frames characterizing differences therefrom. In some cases, a user may step through such time slices by “playing” the sequence of data structures or the user may manually advance time-slice by time-slice, annotating as they go. In some cases, annotations from a time-slice may be proposed for a subsequent time-slice by matching structures (that may have moved in data space) there between, e.g., by using Sum of Absolute Differences (SAD) or Sum of Squared Differences (SSD) to detect the best matching voxels between adjacent time-slices.

The external data source 150 may include one or more storage systems or data services configured to provide volumetric image data to the computing system 110 for visualization and segmentation, and to receive modified or derived data outputs from the computing system 110. In some embodiments, the external data source 150 may be implemented as a local, physically connected storage device, such as a hard disk drive, solid-state drive, or portable data storage unit containing one or more volumetric datasets. Such local storage may be accessed via a file system interface or memory-mapped data access layer and may provide raw or preprocessed image volumes to the data management engine 125 for integration into the hierarchical spatial data structure.

In other embodiments, the external data source 150 may be implemented as a cloud-based storage service or network-accessible database. In such cases, the computing system 110 may retrieve volumetric image data from the external data source 150 using network protocols, application programming interfaces (APIs), or secure transfer protocols. The external data source 150 may also support bi-directional communication, allowing the computing system 110 to transmit segmentation labels, edited volumetric volumes, user annotations, or metadata outputs back to the data source for storage, synchronization, or access by other systems. Cloud-based implementations may further support collaboration across distributed user sessions or storage of user-specific labeling histories for downstream analysis.

In some embodiments, the external data source 150 may correspond to a server-based infrastructure, such as a networked file server, database server, or institutional data repository. The server may be hosted by an academic, medical, industrial, or commercial entity, and may store volumetric datasets such as MRI, CT, PET, or microscopy volumes for use in research, diagnostics, or education. For example, in an educational deployment, the external data source 150 may be managed by an instructor and contain curriculum-linked image volumes for classroom use, while in a medical implementation, the data source may include patient imaging records accessed under regulatory-compliant protocols. As with other components of the system, the external data source 150 may be integrated into a cloud-based infrastructure alongside the visualization engine 115, segmentation engine 120, or other system elements, and may support concurrent access by multiple computing systems 110 across different geographic locations or user roles.

In some embodiments, a cloud-based or server-based implementation of the external data source 150 may support collaborative workflows across distributed computing systems 110 or head-mounted spatial interaction systems 190. For example, multiple users may access the same volumetric image dataset concurrently from different geographic locations, with each user interacting through their respective client device. The external data source 150 may manage shared access to the dataset and maintain a synchronization layer that tracks segmentation updates, region-of-interest selections, or brush trajectories performed by each user. These updates may be stored as part of a shared or user-specific session, allowing for live collaboration, instructor-led demonstrations, peer review, or sequential proofing of labeled structures.

In some embodiments, the system may support session identifiers, user roles, or permission levels to control how edits are propagated or visualized. For example, a primary reviewer may be permitted to apply final segmentation labels, while other users contribute proposed annotations or highlight uncertain regions. Visualizations may be synchronized in near-real time across users by transmitting only differential updates, such as changed label fields or updated bitfield metadata, reducing bandwidth usage and enhancing responsiveness. In educational contexts, a central instructor system may oversee multiple student users interacting with assigned datasets, with the external data source 150 managing submission, review, and archival of labeled outputs. In medical deployments, collaborative review may support team-based annotation or consensus-driven segmentation of diagnostic datasets, with full audit trails and temporal tracking of user contributions.

In some embodiments, the head-mounted spatial interaction system 190 may include a head-mounted display (HMD) and a pair of handheld, motion-tracked controllers. Each controller may be configured to provide six-degree-of-freedom spatial tracking, including position and orientation data, based on one or more gyroscopes, accelerometers, optical sensors, or magnetic tracking systems. The HMD may include stereoscopic display panels configured to present a rendered volumetric scene corresponding to the user's viewpoint, which is dynamically updated based on real-time head pose tracking. The user may manipulate virtual tools such as segmentation brushes, menus, or region selection volumes using the tracked controllers, facilitating voxel-level interaction with volumetric image data in an immersive environment.

In some embodiments, the head-mounted spatial interaction system 190 may include a headset in combination with a single tracked controller or other tracked input device, such as a stylus, glove, or eye-tracking system. In some embodiments, the system may not include a motion-tracked controller at all and may instead receive user input through a non-spatial interface such as a keyboard, mouse, touchpad, or touchscreen, while still providing volumetric visualization through the headset. In some embodiments, the system may omit (which is not to imply that other things cannot be omitted) the head-mounted component entirely and provide volumetric visualization on an external display, such as a monitor or projection surface, with user input provided by any suitable interaction modality, including tracked input devices, haptic controllers, pointer-based systems, or 2D interfaces.

In some embodiments, the system may display a visual representation of a three-dimensional image volume in a form navigable by the user and may receive user input designating a region of interest or segmentation path based on the user's actions within the input modality's available degrees of freedom. For example, in a non-head-mounted embodiment, the volumetric data may be visualized within a manipulable 3D viewport on a monitor, and brush trajectory input may be defined by mouse-driven ray intersections or stylus input on a tablet surface. The system architecture is thus not limited to a particular form factor or device combination but may instead encompass a range of immersive or semi-immersive configurations, each supporting user interaction with spatially organized volumetric image data.

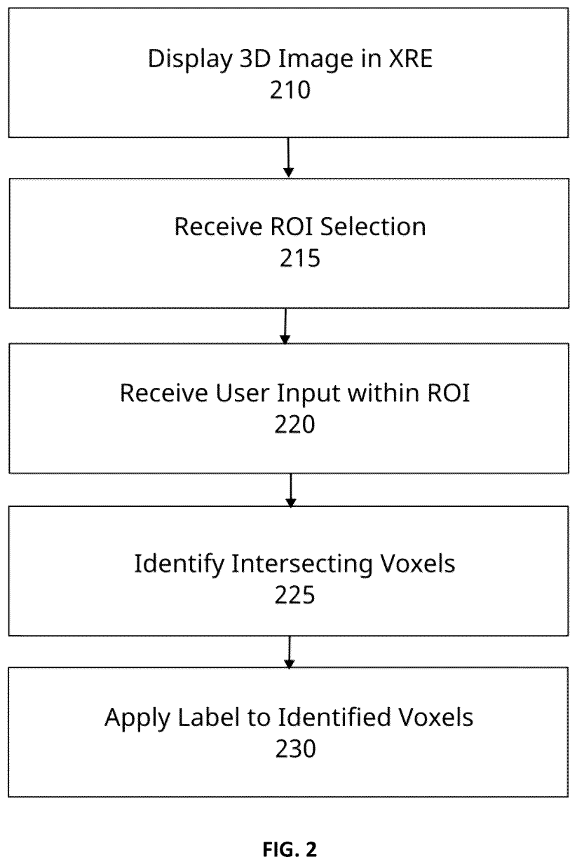

FIG. 2 illustrates an example method for segmenting volumetric image data in an extended reality environment. The method, in some embodiments, includes displaying a multiresolution three-dimensional image volume, receiving spatial input from the user, and applying segmentation labels to identified voxels. Some embodiments include the reception of a brush-based user input within a region of interest and the identification of intersected voxels based on that input. These steps are expected to help with intuitive, freeform interaction in 3D space, allowing the user to directly “paint” segmentations into the volume using natural movements. In some embodiments, user selections spanning a trajectory or volume in three (or six) dimensions of physical space by moving their input device therein may be mapped to voxels in data space.

At step 210, the system may display a multiresolution representation of a three-dimensional image volume in an extended reality environment. The multiresolution representation may be implemented with a hierarchical arrangement of volumetric data that includes two or more resolution levels, which may be precomputed during an initial preprocessing or data ingestion phase, or dynamically generated, streamed, or synthesized at runtime in response to system load, user interaction, or display context. In some embodiments, these resolution levels may be computed by downsampling, interpolation, or block-level aggregation methods applied to the original image volume. The step 210 may involve rendering a stereoscopic or monoscopic view of the volumetric image data based on the user's current spatial pose within the immersive environment. The volumetric image data may be stored in a hierarchical spatial data structure, such as an octree, a bounding volume hierarchy (BVH), or another multiresolution spatial partitioning scheme that subdivides the image volume into blocks of varying resolution. The rendering system may selectively access and visualize these blocks based on the user's head pose, gaze direction, interaction history, or resolution selection policies, which may vary dynamically across time and space. In some cases, the data to be visualized may not be obtained in the form of a hierarchical spatial data structure from a sensor, but such a data structure may be pre-computed by some embodiments from that sensor data, e.g., prior to a viewing session, to make limited computing resources more performant during later viewing sessions.

In some embodiments, the immersive environment may be implemented as an extended reality (XR) environment, which may include combinations of VR and AR modes or transitional experiences between physical and virtual contexts. In some embodiments, the system may adapt its rendering parameters based on the capabilities of the display hardware, the available interaction modalities, and the user's current spatial pose, facilitating intuitive exploration and segmentation of volumetric image data across a range of immersive environments. In some embodiments, the system may operate in a virtual reality (VR) environment, in which the user's entire field of view is occupied by the rendered volumetric image volume or a surrounding virtual workspace. In some embodiments, the system may be deployed within an augmented reality (AR) environment, such as one in which the volumetric image volume is rendered as an overlay or anchored element within the user's physical environment, such that real-world and virtual content are viewed and displayed (respectively) concurrently.

In some embodiments, rendering at step 210 is performed using volume rendering techniques such as DVR, MIP, or slice-based compositing, which may be implemented using CPU- or GPU-accelerated graphics pipelines. The visualization engine may determine a view frustum or camera model corresponding to the user's head-mounted display pose and traverse the hierarchical data structure to retrieve voxel data for regions that fall within or intersect the user's view. Fine-resolution blocks may be rendered at native resolution, while coarser blocks may be upsampled or approximated to minimize latency and memory usage. The result may be a continuously updated display of the 3D image volume that responds to the user's movement and focus.

In some implementations, the volumetric data may be displayed as a free-floating structure in the user's virtual field of view, while in others it may be embedded in a manipulable viewport or reference frame within the virtual space. Some embodiments may support display within augmented reality environments, where the image volume is composited over the user's physical surroundings, anchored to a fixed point in space, or attached to a real-world object. The system may further support display on external screens or in shared viewing environments, while still applying the same resolution-aware rendering logic described above.

At step 215, the system may receive a selection of a region of interest (ROI) within the three-dimensional image volume using an extended reality interface. In some embodiments, the region of interest may be selected explicitly by the user through an interaction with a spatial input device, such as a handheld controller, tracked pointer, or stylus, operating in conjunction with a head-mounted display. In some embodiments, the region of interest may be selected explicitly by the user through an interaction with a spatial input device, such as a handheld controller, tracked pointer, or stylus, operating in conjunction with a head-mounted display. In other embodiments, the region of interest may be determined automatically based on the user's field of view as defined by the pose of the head-mounted display, such that the ROI corresponds to a subvolume aligned with the user's current gaze direction or frustum. In some cases, the region of interest may be established without any direct user interaction, for example, using a deterministic rule set, a predefined scan path, or a system-inferred interaction window that anticipates the user's focus based on previous segmentation history or scene saliency. In some embodiments, the user may define the ROI by positioning a bounding box, lasso, or brush cursor within the virtual space and confirming a selection via a button press, gesture, or dwell time. In other embodiments, the region of interest may be implicitly determined based on a combination of user viewpoint and controller orientation, such as by aligning a selection volume with the center of the user's field of view or interaction ray.

The region of interest may encompass a bounded subvolume of the full volumetric image data and may be represented internally as a set of block references within the hierarchical spatial data structure. In some implementations, the selected ROI may be displayed visually within the immersive environment as an outlined or semi-transparent box, sphere, or arbitrary shape, providing the user with immediate visual feedback as to which portion of the volume is active. The system may restrict subsequent segmentation, rendering, or interaction steps to the selected region of interest, thereby improving performance and focusing the user's attention on a manageable subset of the total volume.

In alternative embodiments, in augmented or virtual reality settings, the ROI may be selected through gesture-based input, gaze tracking, or voice commands. The system may also support planar ROI definitions (e.g., selecting a slice or cross-section) or sequential selection workflows in which multiple regions are defined and edited in succession. In desktop-style configurations, the ROI may be defined using traditional interfaces such as a mouse or touchscreen, with the resulting region mapped into the 3D coordinate space of the image volume. Regardless of the specific interface, the selected region of interest serves as a spatial filter that constrains which portion of the volumetric dataset is targeted by subsequent segmentation or labeling operations.

At step 220, the system may receive user input within the previously defined region of interest. This input may represent the user's intent to interact with, modify, or annotate a specific subregion of the volumetric image volume. The system may receive this input through one or more input modalities associated with an extended reality interface. In general, the user input may be interpreted as a spatial signal—such as a gesture, path, or pointer movement—mapped to coordinates within the three-dimensional data space of the region of interest.

In some embodiments, the user input comprises a brush trajectory, defined by the motion of a handheld, spatially tracked input device (which may be their hand when tracked by cameras and performing a gesture the system is configured to recognize, for example). For example, the user may manipulate a controller, stylus, or wand equipped with six-degree-of-freedom tracking, and the system may record the position and orientation of the device at discrete time intervals. These samples may be interpolated or processed into a continuous spatial path, referred to as a brush trajectory, which passes through the region of interest. The system may associate a volumetric brush shape (such as a sphere, cube, axis-aligned disk, or adjustable cylinder) with the trajectory, such that the user's motion through space defines a swept volume of potential interaction. This swept volume may then be used in subsequent steps to determine which voxels are intersected and eligible for segmentation.

In some embodiments, the brush trajectory may be defined using other types of spatial input devices, such as a head-mounted stylus, tracked fingertip, optical hand-tracking interface, or controller-free gesture recognition system. The input may also be derived from gaze-based selection, where the user's gaze vector and dwell time define the intended path or interaction region. In some configurations, particularly those that do not rely on immersive hardware, the brush trajectory may be defined through traditional input methods such as mouse drag events, touchscreen swipes, or pen input on a tablet interface. In such cases, the system may project the two-dimensional input path into the three-dimensional volume using ray casting or similar transformation techniques to generate a corresponding volumetric brush trajectory. Regardless of the input modality, the system may associate the received user input with a spatial path in data space that forms the basis for voxel identification in subsequent steps.

In some embodiments, the brush trajectory may be tracked and represented directly in data space, where the positions defining the path are expressed in the same coordinate system as the volumetric image volume. For instance, the spatial path of the brush may be sampled and stored using floating-point coordinates corresponding to voxel-aligned or normalized units within the volume. When tracked in data space, the trajectory may be used without additional transformation for direct intersection testing with voxel positions, allowing precise and efficient determination of affected voxels or subregions.

In some embodiments, the brush trajectory may initially be recorded in real-world space, such as in the coordinate frame of the head-mounted display system or a controller-based input tracking environment. In such cases, the system may apply a transformation matrix (such as a view-to-volume mapping or a world-to-volume calibration) to convert the raw trajectory samples into data space coordinates. This mapping may account for scaling, translation, and rotation between the physical interaction space and the internal representation of the image volume. In systems supporting physical-space overlay (e.g., AR or XR environments), the mapping may also consider alignment with anatomical landmarks or calibration targets within the user's environment.

In some embodiments, the brush trajectory may originate in pixel space, such as from 2D pointer input, screen-aligned drag paths, or stylus interactions on a virtual surface. The system may interpret such inputs using ray projection, inverse camera transformations, or depth-informed interpolation to project the two-dimensional trajectory into a three-dimensional path that intersects the volumetric image data. Once projected into data space, the trajectory may be analyzed and processed identically to trajectories defined directly in real-world or data-space coordinates.

In some embodiments, a brush generator module may employ a compact, edge-aware convolutional neural network to determine, for each streaming six-degree-of-freedom pose received from an input controller, a parametric hull that defines a local painting volume. The neural network may accept as input a tensor of voxel intensities acquired from a sliding cubic window centered on a cursor position indicated by the most recent pose. The network may apply successive three-dimensional convolutions having kernel sizes that decrease with depth, each followed by a rectified-linear activation stage and an optional instance-normalization stage, to capture both coarse contextual information and fine edge detail that delineates anatomical boundaries. An intermediate feature pyramid may be aggregated using learned attention weights so that spatial locations exhibiting high gradient magnitude along tissue interfaces contribute disproportionately to the subsequent regression layers. A final fully connected layer may emit a vector whose components represent, for example, a radius value and a set of spherical-harmonic coefficients that collectively describe a closed surface. The coefficients may be decoded into a triangulated mesh that conforms to predicted tissue contours, thereby producing an adaptive brush hull.

In some embodiments, the neural network weights may be pruned to remove low-magnitude kernels while retaining accuracy. Some implementations may employ a decision-tree regressor trained on Sobel-filtered intensity gradients or a radial basis function network trained on local texture descriptors. The brush generator may average successive hulls in temporal windows to damp high-frequency jitter, or may enforce a minimum radius constraint to avoid degeneration when intensity contrast is ambiguous.

At step 225, the system may identify one or more voxels within the image volume that intersect a user interaction occurring within the region of interest. The interaction may take the form of a spatial selection input previously received in step 220 and may include a brush trajectory. The identification step may involve determining which voxels, within the boundaries of the region of interest, fall within the spatial extent defined by the user's input path, pointer location, swept volume, or other interactive gesture. In some embodiments, the system may perform this step by sampling or rasterizing the user-defined interaction region and evaluating whether each voxel's center point or bounding volume intersects the defined input volume.

In an embodiment where the user input includes a brush trajectory, the system may compute a swept volume from the brush shape and path, such as a cylindrical or capsule-like volume defined by the movement of a spherical brush head along a continuous spatial path. The brush shape may be configurable (e.g., spherical, cubic, or disk-shaped) and may include a radius or bounding box defining its reach. As the brush moves through space, the system determines which voxels fall within the aggregate brush volume and collects those voxels for subsequent processing. The voxel positions may be evaluated relative to a fixed spatial grid aligned with the hierarchical data structure, and intersection checks may be performed at one or more resolution levels depending on the current rendering or editing context.

In some embodiments, the identification of voxels may result from other types of input, such as a point-and-click operation, a raycast from a 2D cursor into the 3D volume, or a volume-filling operation (e.g., flood fill) originating from a user-selected seed point. The region of intersection may also be defined implicitly, such as by time-based dwell in a specific subregion, or by voice-command-based selection of a named structure or pre-tagged region. The voxel identification process may also respect boundaries of the hierarchical structure, such that only voxels from resolution-aligned blocks are considered, and may optionally incorporate clipping planes, threshold filters, or immutability flags to restrict which voxels are eligible for segmentation.

At step 230, the system may apply one or more segmentation labels to the set of voxels identified in step 225. A segmentation label may correspond to an anatomical structure, a user-defined region, a machine learning-inferred classification, or any other categorical identifier relevant to the segmentation task. Each voxel may be associated with a label value indicating its inclusion in a particular mask or class, and the system may support multiple simultaneous labels per voxel in the case of overlapping or multi-class segmentations. Annotations may also include comments, like those entered in natural language text by the user).

The assigned labels may be stored in a segmentation data structure, which may be implemented as a sparse octree or other form of spatially indexed hierarchy. (Or the labels may be stored in a flat volumetric data structure, like as a list of labels with spatial coordinates of vertices of a bounding hull polygon for each). In an octree-based implementation, each node or block within the tree corresponds to a three-dimensional subvolume of the overall image volume. The tree may be constructed recursively such that each parent block may be subdivided into up to eight child blocks at a higher resolution, with each level of the tree representing an increasingly fine-grained resolution tier. Each block within the octree may contain a bit field or similar compact representation indicating which mask identifiers are present within that block. For example, a 32-bit or 64-bit field may be used, with each bit position corresponding to a specific segmentation label. When a voxel within a block is labeled, the bit associated with that label is set, facilitating efficient block-level queries, such as identifying all blocks containing a given mask or determining whether a new mask identifier is available. The bit fields may be propagated upward through the octree as part of a consistency maintenance step, ensuring that each parent block reflects the aggregate label presence of its children.

In some embodiments, the segmentation data structure may include a hashed sparse voxel grid, a skiplist-based spatial index, a block-aligned memory layout with per-voxel label arrays, or a compressed sparse volume representation. These structures may similarly support label storage and propagation, with varying trade-offs in access time, memory footprint, and resolution granularity. In some cases, additional metadata may be stored per block, such as mask label confidence scores, user identifiers, or timestamps associated with edit actions. The segmentation data structure may also support mask deletion, label merging, and resolution-aware export, and may be synchronized with the visualization engine to provide immediate visual feedback as labels are applied or modified.

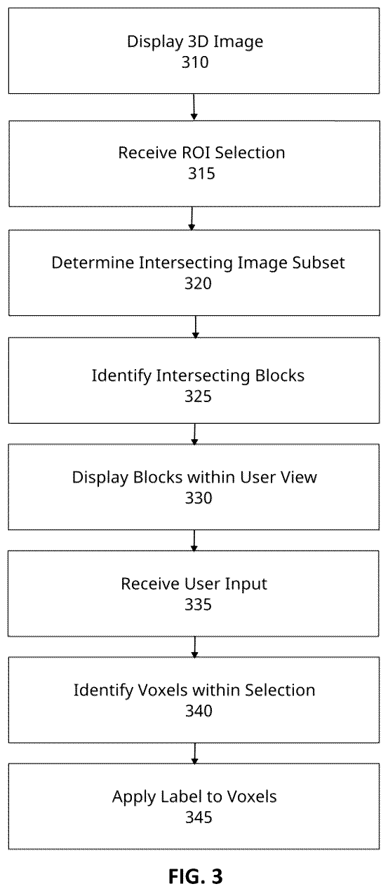

FIG. 3 illustrates an example method for segmenting volumetric image data using a view-dependent, multiresolution approach within an extended reality environment. (FIGS. 2 and 3 depict processes that may be performed with the system of FIG. 1). This method may support selective display of hierarchical blocks of image data based on the user's current viewpoint. The method may support block-level segmentation workflows, where the user selects and interacts with spatial subvolumes (blocks) rather than having to operate directly at the voxel level. This design may streamline interaction by allowing coarse selection with fine control when needed. The embodied method may support assignment of segmentation labels to voxels stored in a hierarchical structure, such as an octree, with associated bit fields that efficiently track which labels are present within each block. This method may facilitate storage, retrieval, and visualization of segmented data at multiple levels of detail without redundant memory usage, providing a scalable solution for large-scale image volumes.

At step 310, the system may display a representation of a three-dimensional image volume in an extended reality environment. The displayed volume may be composed of volumetric image data, which refers to a three-dimensional dataset whose values may represent measured, simulated, or computed intensities or properties at regularly or irregularly spaced coordinates within a volume. In some embodiments, volumetric image data may include MRI, CT, PET, or microscopy datasets that associate each voxel with an intensity value, color, scalar field, or other metadata relevant to scientific, anatomical, or structural interpretation. However, the system is not limited to purely image-derived volumetric data (which is not to imply that other features are limiting). It may also be configured to operate on volumetric data more broadly, such as simulated fluids, scalar fields in engineering analyses, 3D reconstruction data, or synthetic voxel datasets derived from computational models.

The volumetric image data may be imaged datasets or volumetric data that has been computed for purposes of analysis or segmentation (e.g., simulation data). In some embodiments, the segmentation and labeling may be applied to a variety of volumetric datasets that present as a three-dimensional matrix of addressable spatial units (voxels), regardless of whether the source data originated from an imaging modality. The volumetric image data may in some embodiments be radiographic or microscopy-derived datasets, the system architecture is capable of operating with other forms of volumetric data without modification, including those not derived from imaging sources.

In some embodiments, encoding the volumetric image data in a k-d tree may permit selective access, display, and update of each block without requiring access to other blocks at the same or higher resolution levels, thereby afforcing efficient rendering and interaction with very large datasets that exceed available system memory. The hierarchical structure may support view-dependent rendering, block-level segmentation, and resolution-aware interaction, which together allow the system to manage resources effectively while maintaining high responsiveness during segmentation workflows. The displayed representation may be generated in stereoscopic or monoscopic form, using volume rendering techniques that produce continuous visual feedback to the user based on current pose, resolution level, and user interaction state.

The displayed representation may be generated in stereoscopic or monoscopic form, depending on the capabilities of the display system and user preferences. In stereoscopic implementations, the system may generate separate left-eye and right-eye images based on user pose and viewing frustum, allowing the user to perceive depth and spatial relationships within the volumetric data. In monoscopic implementations, such as non-immersive desktop environments or mirrored display modes, a single view may be generated from a fixed or user-defined perspective.

Volume rendering techniques may include direct volume rendering, MIP, ray casting, or transfer-function-based compositing, and may be implemented using CPU-based or GPU-accelerated pipelines. The rendering parameters may adapt dynamically based on changes to the user's head pose, region of interest, or segmentation state. This helps the system to provide continuous visual feedback in response to user actions, including segmentation edits, viewpoint navigation, and block-level updates across different resolution tiers.

At step 315, the system may receive a selection of a region of interest within the image volume using an extended reality interface. In some embodiments, the region of interest selection performed at this step may be identical or functionally equivalent to the region of interest selection described above in connection with step 215. For example, the region of interest may be explicitly selected by the user via a tracked input device or may be determined automatically based on the user's current field of view, prior interaction patterns, or a predefined selection strategy. The selected region may serve as a spatial filter to constrain subsequent operations to a localized subset of the volumetric image data.

At step 320, the system may determine a subset of the image volume that intersects the user view, where the user view is defined by the current position and orientation of the user within an extended reality environment. The user view may be represented by a view frustum, field of view cone, or other projection volume aligned with the user's pose as reported by a head-mounted display or similar tracking system. In some embodiments, the system may calculate which spatial coordinates or hierarchical blocks fall within this view volume and classify those elements as visible, partially visible, or outside the view.

The subset of the image volume intersecting the user view may then be flagged for further processing, such as prioritized rendering, resolution refinement, or segmentation interaction. In certain implementations, the system may also define a foveal subregion within the user view based on eye tracking or centerline projection and may treat this central region with higher fidelity (e.g., selecting finer resolution blocks or performing more frequent updates) relative to peripheral regions. This view-aware subdivision may change dynamically in real time as the user moves or reorients, facilitating an efficient, gaze-aware rendering pipeline. In some embodiments, the user view may be inferred not only from pose but also from contextual cues, such as controller orientation, brush trajectory direction, or prior region-of-interest interaction. The determined subset of the volume may represent a spatially dynamic focus area, suitable for use in adaptive resolution rendering, visibility culling, segmentation triggering, or predictive caching across the hierarchical spatial data structure.

In some cases, the hierarchical data structure may be held in the cloud, at a remote server, because the entire data structure does not fit in memory of the local computing device used to render displays. In some cases, only the portion displayed and adjacent voxels and adjacent resolution levels may be cached locally. Or some embodiments may extrapolate from user inputs to predict and cache locally data that is further from that viewed or at higher or lower levels of granularity.

At step 325, the system may identify blocks that intersect the user's current view frustum and select those blocks for rendering at the first resolution. The rendering may occur in data space, such that voxel values are directly accessed and visualized from high-resolution blocks, or in pixel space, such that higher-resolution data supports more precise color or depth output in the rendered frame. For blocks located outside the view frustum, or in a designated peripheral zone, the system may instead select a lower-resolution version of each block, using downsampling, mipmapping, or hierarchical substitution from a coarser resolution tier. In some embodiments, the system may support three, four, or more distinct resolution levels, depending on system configuration and dataset structure. For example, in an octree-based hierarchy, a block at level L may be replaced with eight child blocks at level L+1 to provide a finer-resolution representation, while coarser blocks at level L−1 may represent aggregated summaries or previews of larger spatial extents. The resolution control engine 130 may use view distance, user interaction history, foveation data, or system load metrics to select the appropriate resolution level for each block independently.

At step 330, the system may display one or more blocks of the image volume at a first resolution within the user view, and one or more blocks at a second, lower resolution outside the user view. The first resolution may correspond to a finer level of detail in the hierarchical spatial data structure, such as the highest currently active resolution tier in an octree or similar multiresolution format, while the second resolution may correspond to a coarser representation of the same image volume, selected to conserve memory bandwidth, GPU cycles, or cache resources.

At step 335, the system may receive user input selecting one or more blocks of the image volume, including blocks displayed at any resolution tier as described in step 325. The blocks selected may include those located within the previously defined ROI, such as that identified in connection with steps 215 or 315, or may include blocks located outside the ROI, such as peripheral blocks that remain visible or accessible to the user for coarse interaction, previewing, or deferred segmentation.

In some embodiments, the selection of blocks may be performed explicitly by the user, for example through interaction with a tracked controller, stylus, gaze-tracked pointer, or virtual menu. The user may point to or highlight one or more blocks in the immersive environment and confirm selection through a button press, gesture, or dwell event. In other embodiments, block selection may be performed automatically by the system based on a predefined interaction model or segmentation policy. For example, blocks intersected by a brush trajectory may be automatically selected when that trajectory enters their spatial bounds, or blocks containing unlabeled voxels near previously edited regions may be preselected for refinement.

In some embodiments, block selection may be performed entirely by the computing system, without any direct user interaction. For example, the system may use predefined criteria, such as spatial continuity with previously segmented blocks, image intensity thresholds, or anatomical heuristics to automatically select relevant blocks. In certain implementations, machine learning models or artificial intelligence modules may analyze the volumetric data and infer which blocks are likely to contain structures of interest, thereby generating a predicted segmentation pathway or identifying candidate blocks for review or refinement. The system may also incorporate feedback loops in which previously labeled blocks inform future selection logic, allowing the block selection process to evolve dynamically as additional regions are segmented. Such AI-assisted or fully autonomous block selection techniques may be used to accelerate manual workflows, provide automated assistance, or support offline processing pipelines where user interaction is limited or unavailable.

The system may also support hybrid selection modes, in which user input acts as a trigger for block selection, but the final list of selected blocks is expanded, filtered, or adjusted by the system based on contextual rules or priority heuristics. For example, selecting a single block may result in adjacent or hierarchically related blocks being selected as well, particularly in cases where segmentation continuity or edge refinement is desired. The block selection process may influence not only segmentation behavior but also caching strategy, prefetching, resolution adjustment, or visualization overlays in subsequent steps.

At step 340, the system may identify a set of voxels contained within one or more blocks that were previously selected in step 335. Each block may correspond to a spatial subvolume of the overall image volume, and the voxels within the block may be organized in a regular grid or sparse structure depending on the implementation of the hierarchical spatial data structure. In some embodiments, the set of voxels is identified by directly accessing the data content of each selected block and reading voxel values, positions, or segmentation states as necessary to support subsequent labeling, editing, or rendering operations.

The voxel identification process may be sensitive to the resolution level of the block from which voxels are retrieved. For example, if a selected block belongs to a higher resolution tier, the set of voxels may be defined at a finer spatial granularity, allowing for more precise segmentation. Conversely, for blocks at a lower resolution tier, the identified voxels may represent coarser approximations of the underlying data, which may be suitable for previewing or rough annotation but not for fine-grained labeling. The system may optionally flag certain voxels for deferred refinement or future processing based on resolution tier or editing context.

In some embodiments, identifying a set of voxels within a selected region or block may include traversing voxel indices that are ordered according to a space-filling curve mapping of three-dimensional spatial coordinates to a one-dimensional index domain. This may involve converting the (x, y, z) coordinate of each voxel into a scalar index along the selected space-filling curve. The resulting linear index may be used to perform range-based queries, to iterate over a local segment of memory-mapped voxel data, or to sort voxels for spatially aware algorithms such as segmentation label propagation or edit replay. Traversal in space-filling curve order may allow for efficient voxel filtering or masking operations in scenarios where segmentation labels, mask bitfields, or voxel intensity values are densely packed and indexed by their ID positions. It may also assist in hierarchical pruning, allowing the system to operate on voxel segments with bounded spatial proximity without reassembling 3D coordinates for each comparison. This ordering approach may be used in combination with brush trajectory sweeps, ROI selection, or block-level segmentation workflows and may improve performance in GPU-accelerated implementations where memory access patterns influence thread execution efficiency.

In some embodiments, the system may further filter or refine the set of identified voxels based on editability constraints, existing segmentation labels, voxel intensity thresholds, or region-of-interest boundaries. For example, voxels already labeled with immutable masks may be excluded, or voxels that fall outside a user-defined brush path may be disregarded. The voxel identification step may also incorporate clipping planes, proximity filters, or brush geometry checks, ensuring that only voxels relevant to the current operation are selected. The result may be a defined subset of voxels within the selected block(s) that are eligible for label assignment in step 345.

At step 345, the system may apply one or more segmentation labels to the voxels identified in step 340. The labeling process may involve writing a value to each selected voxel to indicate its association with a specific segmentation class, user-defined region, or structure of interest. In some embodiments, this process may be identical or functionally similar to the label application step described above in connection with step 230, including support for single- or multi-class labeling, label overwriting, and update propagation across hierarchical levels.

As in some embodiments, the assigned labels may be stored in a segmentation data structure comprising a hierarchical encoding, such as a sparse octree or another multiresolution representation. Each block within the structure may maintain bit fields, label masks, or metadata structures that track the presence of segmentation labels across its contained voxels. The system may update these structures in response to voxel-level changes, optionally propagating updates to parent or child blocks based on resolution-level relationships, system policy, or user intent. The segmentation labels may be used to drive visualization overlays, mask exports, model training datasets, or other downstream applications.

In some embodiments, inputs collected during proofreading or correction of segmentation labels may be logged and used to refine or train a machine learning model. These inputs may include, for example, user-modified brush paths, segmentation label additions or deletions, or manual corrections of previously generated masks. The system may associate these edits with spatial coordinates, label identifiers, or block identifiers in the hierarchical data structure. The logged data may serve as training data for supervised or semi-supervised learning pipelines, supporting the system to identify patterns in correction behavior and automatically highlight regions likely to require future edits. In some implementations, such models may be applied to out-of-sample datasets, including newly imported volumetric image volumes or unseen anatomical variants, to flag voxels or subregions for user review, visual emphasis, or priority in block loading and display. In addition to spatial edits, the system may support contextual annotation of proofreading activity. For example, the user may provide natural language input explaining the reason for an edit, identifying an observed artifact, or classifying a structure. These annotations may be stored alongside the segmentation data and presented to future users of the system, such as reviewers in a quality assurance workflow or collaborators in a research or medical environment. The annotations may be embedded in the visualization layer and displayed contextually in either immersive or traditional computing environments.

In some embodiments, an interaction-logging subsystem may record each editing operation performed within a segmentation workspace, including brush strokes, erasures, and individual label toggles. The subsystem may assign, to every event, spatial indices referencing affected voxel coordinates, the prior label value, the updated label value, and a wall-clock timestamp.

In some embodiments, a learner process executing concurrently with a visualization thread may aggregate events into batches, or the learner process may run after visualization. After receiving a batch, the learner may construct training examples by pairing voxel intensity patches extracted from an associated multiscale image pyramid with corrected label targets derived from the updated mask. A sliding-window sampler may balance class frequencies by stochastically discarding events whose label indices exceed a running quota for the corresponding class.

In some embodiments, parameters θ of a segmentation model f(⋅; θ) may be updated through an online optimization routine such as Adam, using a learning rate that decays according to a power schedule proportional to the total number of processed voxels. Upon completing an update, the learner may update an inference module.

FIG. 4 is a diagram that illustrates an exemplary computing system 1000 in accordance with embodiments of the present technique. A single computing device is shown, but some embodiments of a computing system may include multiple computing devices that communicate over a network, for instance in the course of collectively executing various parts of a distributed application. Various portions of systems and methods described herein, may include or be executed on one or more computing systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computing systems) to implement various processing functions.

I/O device interface 1030 may provide an interface for connection of one or more I/O devices 1060 to computing system 1000. I/O devices may include devices that receive input (e.g., from a user) or output information (e.g., to a user). I/O devices 1060 may include, for example, graphical user interface presented on monoscopic displays (e.g., a cathode ray tube (CRT) or liquid crystal display (LCD) monitor), stereoscopic displays (e.g., 3D TVs, 3D monitors, lenticular displays, parallax barrier displays, active shutter stereoscopic displays, passive polarized stereoscopic displays, anaglyph displays, volumetric displays, and CAVE immersive projection displays), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computing system 1000 through a wired or wireless connection. I/O devices 1060 may be connected to computing system 1000 from a remote location. I/O devices 1060 located on remote computing system, for example, may be connected to computing system 1000 via a network and network interface 1040.

Network interface 1040 may include a network adapter that provides for connection of computing system 1000 to a network. Network interface 1040 may facilitate data exchange between computing system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 1000 or multiple computing systems 1000 configured to host different portions or instances of embodiments. Multiple computing systems 1000 may provide for parallel or sequential processing/execution of one or more portions of the techniques described herein.

Those skilled in the art will appreciate that computing system 1000 is merely illustrative and is not intended to limit the scope of the techniques described herein. Computing system 1000 may include any combination of devices or software that may perform or otherwise provide for the performance of the techniques described herein. For example, computing system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computing system 1000 may also be connected to other devices that are not illustrated or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computing system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 1000 may be transmitted to computing system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computing system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine-readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computing system” performing step A and “the computing system” performing step B can include the same computing device within the computing system performing both steps or different computing devices within the computing system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:
1. A method for labeling volumetric data, comprising: obtaining, with a computing device, access to volumetric data in a hierarchical spatial data structure; displaying, with the computing device, a multiresolution representation of a three-dimensional image volume in an extended reality environment configured to display volumetric data using the hierarchical spatial data structure; receiving, with the computing device, a selection of a region of interest of the image volume; receiving, with the computing device, user input defining a brush trajectory within the region of interest; determining, with the computing device, which voxels within the image volume that intersect the brush trajectory within the region of interest; and labeling, with the computing device, the identified voxels in memory.
2. The method of embodiment 1, wherein the multiresolution representation comprises a hierarchical arrangement of the image volume into a plurality of resolution levels, each resolution level comprising one or more blocks of volumetric data, wherein each block at a given resolution level corresponds to a spatial subvolume of the image volume and is associated with one or more descendant blocks at a higher resolution level that collectively represent the spatial subvolume at increased resolution.
3. The method of embodiment 1, wherein the user input is further specified by a brush, the brush having a shape selected by a user from among a set of options, the set of options comprising at least three of the following: a cube, a sphere, an axis-aligned disk, or an axis-aligned square.
4. The method of embodiment 1, wherein the hierarchical spatial data structure comprises a first node subdivided into eight non-overlapping cubic subregions at a first resolution level, with each node being subdivided into eight non-overlapping cubic subregions at a second resolution level, wherein the first resolution level is less granular than the second resolution level.
5. A method for labeling volumetric data, comprising: obtaining, with a computing device, access to a set of volumetric data; constructing the hierarchical spatial data structure by dividing the image volume into an initial set of spatial subvolumes corresponding to a lowest resolution level; storing the set of volumetric data for each subvolume in one or more blocks assigned to the corresponding resolution level; displaying, by a computing device, a representation of a three-dimensional image volume in an extended reality environment configured to store and access the image volume in the hierarchical spatial data structure comprising a plurality of resolution levels, each resolution level comprising one or more blocks of volumetric data, wherein each block at a given resolution level corresponds to a spatial subvolume of the image volume and is associated with one or more descendant blocks at a higher resolution level that represent progressively smaller subvolumes of the image volume, and wherein the hierarchical spatial data structure is configured to permit individual access, display, or update capability to each block without requiring access to other blocks at a same or higher resolution levels; receiving, by the computing device, a selection of a region of interest within the image volume; determining, by the computing device, a subset of the image volume that intersects a user view defined by a current position and orientation in the extended reality environment; identifying, by the computing device, one or more blocks of the hierarchical spatial data structure that intersects a set of boundaries of the user view; displaying, by the computing device, at a first resolution in data space, one or more blocks of the image volume within the user view; displaying, by the computing device, at a second resolution lower than the first resolution, one or more blocks of the image volume outside the user view; receiving, by the computing device, user input selecting one or more blocks; identifying, by the computing device, a set of voxels contained within the one or more selected blocks; and applying, by the computing device, a label to the identified voxels, the label being stored in association with a segmentation data structure comprising a hierarchical encoding of labeled voxel data.
6. The method of embodiment 5, wherein the representation of the three-dimensional image volume is rendered based on image data received from an external source, the image volume being rendered in a current session without retrieval from local persistent storage.
7. The method of embodiment 5, wherein the hierarchical spatial data structure comprises a recursive arrangement of the image volume into quantized cubic regions, wherein a first region encompasses a portion of volumetric data and is subdivided into eight non-overlapping cubic subregions, each of which is recursively subdivided into eight additional cubic subregions.
8. The method of embodiment 5, wherein the hierarchical spatial data structure comprises a bounding volume hierarchy, k-d tree, skiplist, spatial hash, directed acyclic graph, or quadtree, the spatial data structure configured to recursively subdivide the image volume into spatial subvolumes.
9. The method of embodiment 5, wherein: the hierarchical spatial data structure is organized according to a space-filling curve, and identifying the set of voxels comprises traversing voxel indices that are ordered according to a space-filling curve mapping of three-dimensional spatial coordinates to a one-dimensional index domain.
10. The method of embodiment 5, further comprising: determining, by the computing device, that one or more blocks of the image volume have entered or exited the current user view in the extended reality environment; and adjusting, by the computing device, the resolution of one or more blocks of the image volume in response the determination, wherein blocks entering the user view are rendered at a higher resolution than blocks exiting the user view.
11. The method of embodiment 5, further comprising: marking one or more blocks of the hierarchical spatial data structure as dirty in response to the application of the label; and propagating segmentation information associated with the dirty blocks across different resolution levels of the hierarchical spatial data structure.
12. The method of embodiment 5, further comprising: storing, by the computing device, a history of user view positions within the extended reality environment; and prioritizing, based on the stored history, one or more blocks of the image volume for displaying at a higher resolution.
13. The method of embodiment 5, wherein: the volumetric data comprises a sequence of three-dimensional image volumes corresponding to distinct time steps, and the displaying and segmentation for each time step is performed using a hierarchical spatial data structure instantiated separately for each time step.
14. The method of embodiment 5, further comprising: traversing bit fields associated with blocks of the hierarchical spatial data structure; determining a globally unused label identifier; and applying the label using the determined label identifier wherein the identifier is not in use in any block of the volumetric image volume.
15. The method of embodiment 5, wherein the user input selecting the one or more blocks comprises a brush trajectory defined within the region of interest, and wherein the computing device determines which blocks intersect the brush trajectory in data space.
16. The method of embodiment 15, wherein identifying the set of voxels intersected by the brush trajectory comprises determining, by the computing device, voxel locations that occupy three-dimensional spatial coordinates within the volume, based on a volumetric interaction region defined by the brush trajectory in three-dimensional space.
17. The method of embodiment 15, wherein: the brush trajectory is associated with a volumetric brush tool having a selectable shape, the selectable shape comprising one or more of: a sphere, a cube, an axis-aligned disk, or an axis-aligned square, and identifying the set of voxels intersected by the brush trajectory comprises determining which voxels spatially intersect the selected brush shape based on a position and orientation of an extended reality input device.
18. The method of embodiment 15, wherein the extended reality interface comprises a handheld input device configured to provide six-degree-of-freedom spatial tracking data, and wherein the brush trajectory is derived from a time sequence of position and orientation data received from the input device during user interaction within the extended reality environment.
19. The method of embodiment 15, further comprising updating the region of interest during segmentation based on spatial extension of the brush trajectory, wherein portions of the image volume intersected by continued brush movement are incorporated into the region of interest.
20. The method of embodiment 5, wherein determining the subset of the image volume within the current user view comprises identifying a foveal region of interest based on gaze direction or head pose data received from an extended reality input device, and wherein the one or more blocks rendered at the first resolution are selected based on proximity to the foveal region of interest.
21. The method of embodiment 5, wherein the extended reality environment is deployed in an educational setting comprising a networked computing system, wherein a plurality of users interacts with the volumetric data from a plurality of extended reality headsets.
22. The method of embodiment 5, wherein the volumetric data comprises medical imaging data acquired from a modality selected from the group consisting of computed tomography (CT), magnetic resonance imaging (MRI), ultrasound, and positron emission tomography (PET), and wherein the labels correspond to anatomical structures or pathological regions of interest.
23. The method of embodiment 5, wherein the identifying a set of voxels comprises steps for computing a spatial region within a three-dimensional coordinate space and determining which voxels spatially intersect the computed region.
24. The method of embodiment 5, wherein constructing the hierarchical spatial data structure further comprises: recursively subdividing at least one of the spatial subvolumes into a plurality of child subvolumes, each child subvolume occupying a smaller spatial extent within the image volume than its corresponding parent subvolume, wherein each level of the hierarchical spatial data structure corresponds to a distinct resolution level and comprises one or more blocks of volumetric data, and each block is associated with a particular spatial subvolume at that resolution level and optionally linked to a set of descendant blocks at a higher resolution level.
25. A tangible, non-transitory, machine-readable medium storing instructions that when executed by a data processing apparatus cause the data processing apparatus to perform operations comprising: obtaining, with a computing device, access to volumetric data in a hierarchical spatial data structure; displaying, with the computing device, a multiresolution representation of a three-dimensional image volume in an extended reality environment configured to display volumetric data using the hierarchical spatial data structure; receiving, with the computing device, a selection of a region of interest of the image volume; receiving, with the computing device, user input defining a brush trajectory within the region of interest; determining, with the computing device, which voxels within the image volume that intersect the brush trajectory within the region of interest; and labeling, with the computing device, the identified voxels in memory.
26. A tangible, non-transitory, machine-readable medium storing instructions that when executed by a data processing apparatus cause the data processing apparatus to perform operations comprising: the operations of any one of embodiments 1-24.

What is claimed is:

1. A method for labeling volumetric data, comprising:
obtaining, with a computing device, access to volumetric data in a hierarchical spatial data structure;
displaying, with the computing device, using the hierarchical spatial data structure, a representation of a three-dimensional image volume in an extended reality environment configured to display volumetric data;
receiving, with the computing device, a selection of a region of interest of the image volume;
receiving, with the computing device, user input defining a brush trajectory within the region of interest;
determining, with the computing device, which voxels within the image volume that intersect the brush trajectory within the region of interest; and
labeling, with the computing device, the identified voxels in memory.

2. The method of claim 1, wherein the multiresolution representation comprises a hierarchical arrangement of the image volume into a plurality of resolution levels, each resolution level comprising one or more blocks of volumetric data, wherein each block at a given resolution level corresponds to a spatial subvolume of the image volume and is associated with one or more descendant blocks at a higher resolution level that collectively represent the spatial subvolume at increased resolution.

3. The method of claim 1, wherein the user input is further specified by a brush, the brush having a shape selected by a user from among a set of options, the set of options comprising at least three of the following: a cube, a sphere, an axis-aligned disk, or an axis-aligned square.

4. The method of claim 1, wherein the hierarchical spatial data structure comprises a first node subdivided into eight non-overlapping cubic subregions at a first resolution level, with each node being subdivided into eight non-overlapping cubic subregions at a second resolution level, wherein the first resolution level is less granular than the second resolution level.

5. A method, comprising:
obtaining, with a computing system, access to a set of volumetric data comprising an image volume;
constructing a hierarchical spatial data structure by dividing the image volume into an initial set of spatial subvolumes corresponding to a lowest resolution level;
storing the set of volumetric data for each subvolume in one or more blocks assigned to a corresponding resolution level;
displaying, by a computing device, a three-dimensional representation of the image volume in an extended reality environment configured to store and access the image volume in the hierarchical spatial data structure comprising a plurality of resolution levels, each resolution level comprising one or more blocks of volumetric data,
wherein each block at a given resolution level corresponds to a spatial subvolume of the image volume and is associated with one or more descendant blocks at a higher resolution level that represent progressively smaller subvolumes of the image volume, and
wherein the hierarchical spatial data structure is configured to permit individual access, display, or update capability to each block without requiring access to other blocks at a same or higher resolution levels;
receiving, by the computing device, a selection of a region of interest within the image volume;
determining, by the computing device, a subset of the image volume that intersects a user view defined by a current position and orientation in the extended reality environment;
identifying, by the computing device, one or more blocks of the hierarchical spatial data structure that intersects a set of boundaries of the user view;
displaying, by the computing device, at a first resolution in data space, one or more blocks of the image volume within the user view;
displaying, by the computing device, at a second resolution lower than the first resolution, one or more blocks of the image volume outside the user view;
receiving, by the computing device, user input selecting one or more blocks;
identifying, by the computing device, a set of voxels contained within the one or more selected blocks; and
applying, by the computing device, a label to the identified voxels, the label being stored in association with a segmentation data structure comprising a hierarchical encoding of labeled voxel data.

6. The method of claim 5, wherein the three-dimensional representation of the image volume is rendered based on image data received from an external source, the image volume being rendered in a current session without retrieval from local persistent storage.

7. The method of claim 5, wherein the hierarchical spatial data structure comprises a recursive arrangement of the image volume into quantized cubic regions, wherein a first region encompasses a portion of volumetric data and is subdivided into eight non-overlapping cubic subregions, each of which is recursively subdivided into eight additional cubic subregions.

8. The method of claim 5, wherein the hierarchical spatial data structure comprises a bounding volume hierarchy, k-d tree, skiplist, spatial hash, directed acyclic graph, or quadtree, the spatial data structure configured to recursively subdivide the image volume into spatial subvolumes.

9. The method of claim 5, wherein:
the hierarchical spatial data structure is organized according to a space-filling curve, and
identifying the set of voxels comprises traversing voxel indices that are ordered according to a space-filling curve mapping of three-dimensional spatial coordinates to a one-dimensional index domain.

10. The method of claim 5, further comprising:
determining, by the computing device, that one or more blocks of the image volume have entered or exited the current user view in the extended reality environment; and
adjusting, by the computing device, the resolution of one or more blocks of the image volume in response the determination, wherein blocks entering the user view are rendered at a higher resolution than blocks exiting the user view.

11. The method of claim 5, further comprising:
marking one or more blocks of the hierarchical spatial data structure as dirty in response to the application of the label; and
propagating segmentation information associated with the dirty blocks across different resolution levels of the hierarchical spatial data structure.

12. The method of claim 5, further comprising:
storing, by the computing device, a history of user view positions within the extended reality environment; and
prioritizing, based on the stored history, one or more blocks of the image volume for displaying at a higher resolution.

13. The method of claim 5, wherein:
the volumetric data comprises a sequence of three-dimensional image volumes corresponding to distinct time steps, and
the displaying and segmentation for each time step is performed using a hierarchical spatial data structure instantiated separately for each time step.

14. The method of claim 5, further comprising:
traversing bit fields associated with blocks of the hierarchical spatial data structure;
determining a globally unused label identifier; and
applying the label using the determined label identifier wherein the identifier is not in use in any block of the volumetric image volume.

15. The method of claim 5, wherein the user input selecting the one or more blocks comprises a brush trajectory defined within the region of interest, and wherein the computing device determines which blocks intersect the brush trajectory in data space.

16. The method of claim 15, wherein identifying the set of voxels intersected by the brush trajectory comprises determining, by the computing device, voxel locations that occupy three-dimensional spatial coordinates within the volume, based on a volumetric interaction region defined by the brush trajectory in three-dimensional space.

17. The method of claim 15, wherein:
the brush trajectory is associated with a volumetric brush tool having a selectable shape, the selectable shape comprising one or more of: a sphere, a cube, an axis-aligned disk, or an axis-aligned square, and
identifying the set of voxels intersected by the brush trajectory comprises determining which voxels spatially intersect the selected brush shape based on a position and orientation of an extended reality input device.

18. The method of claim 15, wherein the extended reality interface comprises a handheld input device configured to provide six-degree-of-freedom spatial tracking data, and wherein the brush trajectory is derived from a time sequence of position and orientation data received from the input device during user interaction within the extended reality environment.

19. The method of claim 15, further comprising updating the region of interest during segmentation based on spatial extension of the brush trajectory, wherein portions of the image volume intersected by continued brush movement are incorporated into the region of interest.

20. The method of claim 5, wherein determining the subset of the image volume within the current user view comprises identifying a foveal region of interest based on gaze direction or head pose data received from an extended reality input device, and wherein the one or more blocks rendered at the first resolution are selected based on proximity to the foveal region of interest.

21. The method of claim 5, wherein the extended reality environment is deployed in an educational setting comprising a networked computing system, wherein a plurality of users interacts with the volumetric data from a plurality of extended reality headsets.

22. The method of claim 5, wherein the volumetric data comprises medical imaging data acquired from a modality selected from the group consisting of computed tomography (CT), magnetic resonance imaging (MRI), ultrasound, microscopy-derived datasets, and positron emission tomography (PET), and wherein the labels correspond to anatomical structures or pathological regions of interest.

23. The method of claim 5, wherein the identifying a set of voxels comprises steps for computing a spatial region within a three-dimensional coordinate space and determining which voxels spatially intersect the computed region.

24. The method of claim 5, wherein constructing the hierarchical spatial data structure further comprises:
recursively subdividing at least one of the spatial subvolumes into a plurality of child subvolumes, each child subvolume occupying a smaller spatial extent within the image volume than its corresponding parent subvolume,
wherein each level of the hierarchical spatial data structure corresponds to a distinct resolution level and comprises one or more blocks of volumetric data, and each block is associated with a particular spatial subvolume at that resolution level and optionally linked to a set of descendant blocks at a higher resolution level.

25. A tangible, non-transitory, machine-readable medium storing instructions that when executed by a data processing apparatus cause the data processing apparatus to perform operations comprising:
obtaining, with a computing device, access to volumetric data in a hierarchical spatial data structure;
displaying, with the computing device, a multiresolution representation of a three-dimensional image volume in an extended reality environment configured to display volumetric data using the hierarchical spatial data structure;
receiving, with the computing device, a selection of a region of interest of the image volume;
receiving, with the computing device, user input defining a brush trajectory within the region of interest;
determining, with the computing device, which voxels within the image volume that intersect the brush trajectory within the region of interest; and
labeling, with the computing device, the identified voxels in memory.
